(19) United States
(12) Patent Application Publication
(10) Pub. No.: US 2008/0044720 A1
(43) Pub. Date: Feb. 21, 2008

(54) Membrane electrode assembly having porous electrode layers, manufacturing method thereof, and electrochemical cell comprising the same

(75) Inventors: Sang Bong Moon, Seoul (KR); Tae Lim Lee, Seoul (KR)

Correspondence Address: John M. Janeway;GRAYBEAL JACKSON HALEY LLP, Suite 350, 155-108th Avenue NE, Bellevue, WA, 98004-5973, US

(73) Assignee: Elchem Tech Co., Ltd.

(21) Appl. No.: 11/506,496

(22) Filed: Aug. 18, 2006

(51) Int. Cl. H01M 4/86; H01M 4/88

(52) U.S. Cl. 429/40; 502/101

(57) ABSTRACT

The present invention relates to a membrane electrode assembly for electrochemical cells, and a manufacturing method thereof. In the membrane electrode assembly, electro-catalytic layers forming electrodes on both surfaces of an ion-exchange membrane have a plurality of pores evenly distributed therein. According to the invention, the electro-catalytic layers are made porous, and thus the amount of precious metal used can be reduced so that the manufacturing cost of the catalytic layers can be greatly reduced. In addition, the reaction efficiency of the catalytic layers can be stabilized to improve the efficiency thereof.

### BACKGROUND OF THE INVENTION

1. Field of the Invention

The present invention relates to an electrochemical cell, and more particularly to a membrane electrode assembly for electrochemical cells, which has porous electro-catalytic layers on both surfaces of an ion-exchange membrane, as well as a manufacturing method thereof and an electrochemical cell comprising this membrane electrode assembly.

2. Description of the Prior Art

The electrochemical cells are energy conversion devices which are categorized as electrolytic cells or fuel cells. The electrolytic cell is a device for producing hydrogen and oxygen by the water electrolysis, whereas the fuel cell is a device for producing electricity by the electrochemical reaction between hydrogen and oxygen.

For example, a proton exchange membrane electrolysis cell produces hydrogen gas and oxygen gas by the electrolysis of water. FIG. 1 is a schematic diagram showing a typical electrolytic cell for producing hydrogen gas and oxygen gas by the water electrolysis. As shown in FIG. 1, water (H₂O) is fed to an anode 110 (oxygen electrode), at which it is decomposed into oxygen gas (O₂), electrons (e⁻) and hydrogen ions (H⁺) (protons). At this time, some of the water (H₂O) flows out of an electrolytic cell 100 together with oxygen gas (O₂). The protons (H⁺) migrate through a proton-exchange membrane 120 to a cathode 130 (hydrogen electrode), at which they react with electrons (e⁻) that migrated along an external circuit connecting the anode 110 with the cathode 130, thus forming hydrogen gas (H₂). Also, water (H₂O), having passed through the proton-exchange membrane 120 together with protons (H⁺), flows out of the electrolytic cell 100. In the regard, electrochemical reactions occurring in the anode 110 and the cathode 130, respectively, are expressed as shown in reaction equations 1 and 2 below.

2H₂O→4H⁺+4e⁻+O₂(anode) [Reaction equation 1]

4H⁺+4e⁻→2H₂(cathode) [Reaction equation 2]

Reactions in the fuel cell occur in reverse to the above-described electrolytic reaction mechanism of water. Specifically, in the fuel cell, oxygen reacts with hydrogen, methanol or other hydrogen fuel sources to produce electricity. In this regard, general reactions occurring in the fuel cell are expressed as shown in equations 3 and 4 below.

2H₂→4H⁺+4e⁻(anode) [Reaction equation 3]

4H⁺+4e⁻+O₂→2H₂O(cathode) [Reaction equation 4]

This electrochemical cell comprises a membrane electrode assembly (hereinafter, referred to as an “MEA”) having an anode and a cathode, a frame configured to allow the supply and discharge of electrons, reactants, and products, a separator, an MEA support, and a gasket (packing). This electrolytic cell should satisfy requirements that include excellent electrolytic performance and durability and low cost.

Regarding electrolytic performance, the theoretical decomposition voltage in water electrolysis for the electrolysis of water is 1.23 V at a temperature of 25° C., but a higher voltage is required for practical applications. In this respect, the difference between the actual voltage and the theoretical decomposition voltage is defined as overvoltage, which is the sum of the overvoltages of an ion-exchange membrane, an anode, and a cathode, which are the components of the electrolytic cell. Among these overvoltage elements, the cathode overvoltage is overvoltage occurring during the generation of hydrogen and is not high, because the hydrogen generation reaction is reversible. On the other hand, the anode overvoltage has a relatively high value compared to other overvoltages, due to the irreversible generation of oxygen. For this reason, it is highly desirable to improve the electrode for oxygen generation.

The durability of the electrochemical cell is determined by the contact resistance and bonding strength between the ion-exchange membrane and the electrodes (anode and cathode), and thus greatly depends on the method for manufacturing an MEA. In this respect, in order to maintain high durability of the electrochemical cell, the ion-exchange membrane and the electrodes should have a low contact resistance and high bonding strength therebetween.

Therefore, it is important to design a structure and catalytic composition of an MEA.

Methods for manufacturing an MEA generally include a hot pressing method, an electrochemical method and an adsorption reduction method. The hot pressing method is a method of forming an assembly by hot pressing fine catalyst particles and a binder, such as PTFE (polytetrafluoroethylene), onto the ion-exchange membrane. However, the membrane electrode assembly manufactured by hot pressing has a problem of durability, because it is formed by physically bonding phases having different physical properties. On the other hand, the adsorption reduction method comprises reacting a metal salt aqueous solution with a reducing agent on the surface of the electrodes and can increase the adhesion strength of the electrode catalyst and also substantially remove the interfacial resistance between the electrode catalyst and the ion-exchange membrane.

In one example of the adsorption reduction method, in the year 1993, Chen and Chou (J. Electroanalytical. Chem 360, 247-59) manufactured an MEA by adsorbing cation-exchange membrane Nafion (available from DuPont) with lead and palladium and subjecting the Nafion to a reduction reaction with sodium borohydride and lithium hydroxide. The manufactured MEA was applied to electrochemically reduce benzaldehyde. In a similar method, in the year 1995, Millet et al. (J. Appl. Electrochem, 25 227-32) manufactured a ruthenium anode and implemented the manufactured ruthenium anode in a water electrolytic cell. The ruthenium anode has low potential compared to a platinum anode, but has a problem of corrosion. For this reason, in order to improve the instability of ruthenium, an anode made of ruthenium and platinum was thereafter manufactured.

Although this adsorption reduction method has excellent durability, it has disadvantages in that most of electrode catalysts formed on the ion-exchange membrane cannot be effectively used to reduce electrolytic performance, and an excessive amount of precious metal catalysts should be used.

Hereinafter, a process of manufacturing an MEA using the prior adsorption reduction method will be described in detail.

As an ion-exchange membrane, a perfluorosulfonic cation-exchange membrane Nafion, commercially available from DuPont, is used. Both surfaces of the ion-exchange membrane are first roughed with sandpaper (Norton 600A), and then the membrane is immersed in ultrapure water for about 1 hour, taken from the water and cut to a given size. Thereafter, electro-catalytic layers (anode and cathode) are formed on both surfaces of the ion-exchange membrane, respectively, in the following manner.

A. Formation of Cathode Catalytic Layer

(1) Pretreatment Step

In order to remove organic substances present in the ion-exchange membrane cut to a given size, the ion-exchange membrane was heated in a 3% H₂O₂ aqueous solution for about 40 minutes and then washed with pure water. Also, the ion-exchange membrane was heated in 1M H₂SO₄ solution for about 30 minutes, washed with pure water, and then heated in ultrapure water for about 1 hour.

(2) Adsorption Step

Methanol containing 0.6 mM pt(NH₃)₄Cl₂(tetra-amine platinum chloride hydrate, 98%), and water are mixed with each other at a volume ratio of 1:3 to make a mixed solution, and the ion-exchange membrane washed in the pretreatment step was immersed in the mixed solution for about 40 minutes such that the platinum ions are diffused and adsorbed on the inside of the ion-exchange membrane.

(3) Reduction Step

A solution of pH 13, preheated to 50° C., is mixed with NaBH₄ to make a 1 mM reduction solution, in which the ion-exchange membrane is then immersed to remove the platinum solution adsorbed in the adsorption step. Then, 60 ml of the reduction solution is added thereto. Then, the resulting solution containing the ion-exchange membrane is subjected to a reduction process for about 2 hours with stirring, and after completion of the reduction process, the ion-exchange membrane is immersed in 0.5M H₂SO₄ for about 2 hours and in ultrapure water for about 1 hour, followed by storage.

B. Formation of Anode Catalytic Layer

(1) Pretreatment Step

The ion-exchange membrane is washed with pure water and heated in ultrapure water for about 1 hour.

(2) Adsorption Step

This step is conducted in the same manner as the adsorption step in the process of forming the cathode catalytic layer.

(3) Reduction Step

This step is conducted in the same manner as the reduction step in the process of forming the cathode catalytic layer.

FIG. 2 is a photograph of a membrane electrode assembly manufactured according to the prior adsorption reduction method as described above. As can be seen in the photograph of FIG. 2, in the MEA manufactured according to the prior adsorption reduction method, metal covers the entire surface of the ion-exchange membrane to form an electro-catalytic layer (platinum layer).

FIG. 3 is a schematic diagram for explaining the distribution of current in the membrane electrode assembly manufactured according to the prior adsorption reduction method. As shown in FIG. 3, when an anode catalytic layer 310 and cathode catalytic layer 330, located on both surfaces of an ion-exchange membrane, is applied with current in order to electrolyze water, an electrochemical reaction will occur. In this respect, the anode catalytic layer 310 and the cathode catalytic layer 330 serve as a positive electrode and a negative electrode, respectively.

Specifically, fed water (H₂O) moves through an inactive catalytic layer B′ of the anode catalytic layer 310 to an active catalytic layer A′, in which it participates in reaction equation 1 above. After the reaction, oxygen gas (O₂) is discharged to the outside through the active catalytic layer A and the inactive catalytic layer B′. At this time, protons generated by reaction equation 1 move through the ion-exchange membrane 320 to the active catalytic layer A of the cathode catalytic layer 330, in which they form hydrogen gas (H₂) according to reaction equation 2 above. The hydrogen gas (H₂) thus produced is discharged to the outside through the active catalytic layer A and the inactive catalytic layer B. In FIG. 3, the arrows indicate the distribution of current.

Regarding the distribution of an electrochemical reaction occurring in an MEA, at least about 95% of the reaction occurs at a portion through which the two MEA electrodes face each other, i.e., a portion between the active catalytic layer A of the cathode and the active catalytic layer A′ of the anode, and a reaction corresponding to the remaining 5% occurs at portions of the cathode inactive catalytic layer B and the anode inactive catalytic layer B′. Specifically, most of the electro-catalytic layer, which is located at the cathode inactive catalytic layer B and anode inactive catalytic layer B′ of the MEA, does not participate in the electrochemical reaction.

In other words, since the entire surface of the ion-exchange membrane in the MEA manufactured according to the prior adsorption reduction method is coated with metal as shown in the photograph of FIG. 2, water (H₂O) required for the electrochemical reaction is difficult to move to the cathode active catalytic layer A and the anode active catalytic layer A′, and it is difficult to discharge the produced hydrogen gas (H₂) and oxygen gas (O₂). For this reason, since reactions at the cathode inactive catalytic layer B and the anode inactive catalytic layer B′ need to be used, the MEA has a problem in that the catalyst needs to be used in large amounts.

As described above, the MEA manufactured according to the prior adsorption reduction method has excellent durability, but has problems in that an unnecessary electrode catalyst that cannot participate in the electrode reaction is excessively used, the reactant cannot be diffused to the reaction region, which reduces the electrochemical reaction efficiency of the MEA, and the manufacturing cost of the MEA is thus increased.

### SUMMARY OF THE INVENTION

Accordingly, the present invention has been made keeping in mind the above problems occurring in the prior art, and an object of the present invention is to provide a membrane electrode assembly having porous electro-catalytic layers allowing a reactant to easily diffuse to the active catalytic layer of a reaction region, as well as a manufacturing method thereof.

Another object of the present invention is to provide an electrochemical cell comprising a membrane electrode assembly having said porous electro-catalytic layers.

To achieve the above objects, according to one aspect of the present invention, there is provided a membrane electrode assembly for electrochemical cells, which has electro-catalytic layers forming electrodes on both surfaces of an electrolyte membrane, wherein the electro-catalytic layers are porous electro-catalytic layers having a plurality of pores evenly distributed therein.

According to another aspect of the present invention, there is provided a method for manufacturing a membrane electrode assembly for electrochemical cells, which has electro-catalytic layers forming electrodes on both surfaces of an electrolyte membrane, the method comprising: a pretreatment step of washing the electrolyte membrane; an adsorption step of immersing the pretreated electrolyte membrane in a solution containing electrode catalyst ions and easy-to-dissolve metal ions, so as to cause the ions to penetrate into a surface and inside of the electrolyte membrane and fix them thereto; a reduction and dissolution step of reducing the electro-catalytic ions fixed to the electrolyte membrane using a reducing agent to form a catalyst while dissolving the easy-to-dissolve metal ions, thus forming porous electro-catalytic layers; and a post-treatment step of washing the electrolyte membrane having the porous electro-catalytic layers coated on both surfaces thereof.

According to still another aspect of the present invention, there is provided an electrochemical cell comprising: a membrane electrode assembly having electrode catalyst layers forming electrodes on both surfaces of an electrolyte membrane; and a packing, a separator and a frame, which are configured with respect to the membrane electrode assembly so as to make the supply and discharge of a reactant and a product possible, wherein the electro-catalytic layers are porous electro-catalytic layers having a plurality of pores evenly distributed therein.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic diagram of a typical electrolytic cell for producing hydrogen gas and oxygen gas by the electrochemical decomposition of water;

FIG. 2 is a photograph of a membrane electrode assembly manufactured according to the prior adsorption reduction method;

FIG. 3 is a schematic diagram for explaining the distribution of current in the membrane electrode assembly manufactured according to the prior adsorption reduction method;

FIG. 4 is a block diagram showing a process for manufacturing a membrane electrode assembly having porous electro-catalytic layers according to one embodiment of the present invention;

FIG. 5 is a photograph of the electro-catalytic layer of a membrane electrode assembly manufactured according to the present invention;

FIG. 6 is a graphic diagram showing the distribution of pores in the electro-catalytic layer shown in FIG. 5;

FIG. 7 shows the structure of a unit electrochemical cell comprising a membrane electrode assembly manufactured according to the present invention;

FIG. 8 is a process diagram of a test system used to evaluate an electrochemical cell comprising a membrane electrode assembly manufactured according to each of the prior art and the present invention; and

FIG. 9 is a graphic diagram showing the comparison of performance test results between inventive examples and comparative examples, obtained through the test system shown in FIG. 8.

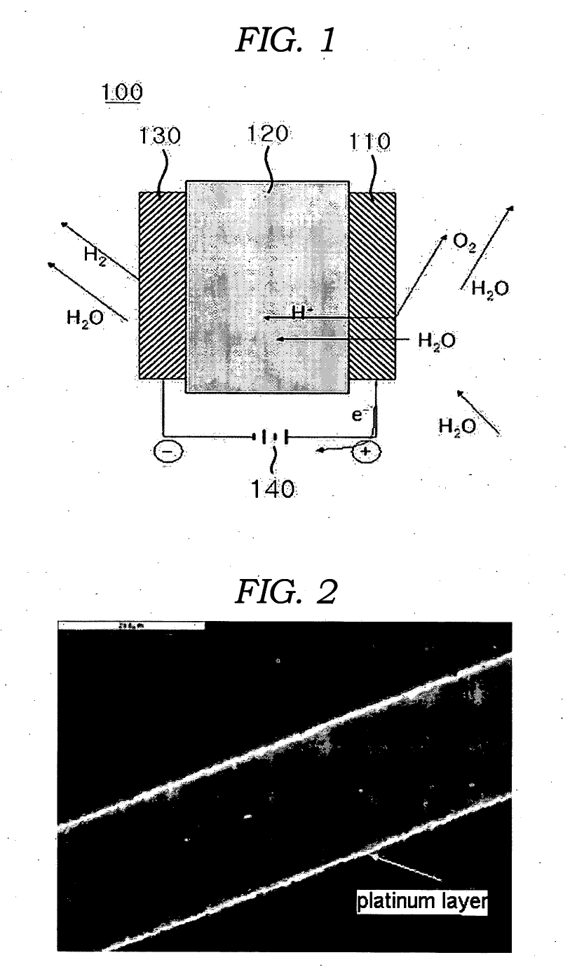

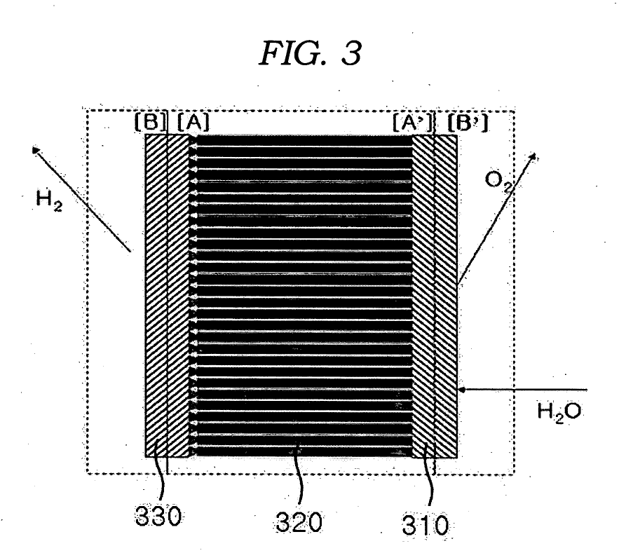

### DETAILED DESCRIPTION OF THE INVENTION

Hereinafter, preferred embodiments of a membrane electrode assembly having porous electro-catalytic layers according to the present invention, a manufacturing method thereof and an electrochemical cell comprising the same will be described in detail with reference to the accompanying drawings.

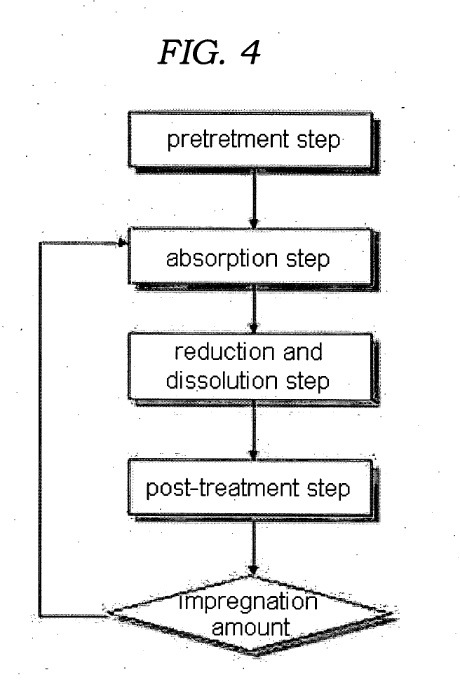

FIG. 4 is a block diagram showing a process of manufacturing a membrane electrode assembly having porous electro-catalytic layers according to one embodiment of the present invention. The membrane electrode assembly (MEA) according to the present invention has porous electro-catalytic layers on both surfaces of an electrolyte membrane (e.g., ion-exchange membrane), and a process of manufacturing the same will be described with reference to FIG. 4.

A method for manufacturing the inventive MEA is performed using the reduction adsorption method and is broadly divided into three steps: (1) a pretreating step of an ion-exchange membrane; (2) an adsorption step of immersing the ion-exchange membrane in a solution containing electro-catalytic ions and easy-to-dissolve metal ions for forming a porous structure, so as to cause ions of metal catalysts to penetrate into the surface and inside of the ion-exchange membrane and fix them thereto; and a reduction and dissolution step of reducing metal ions fixed to the ion-exchange membrane into metal catalysts using a reducing agent and, at the same time, dissolving the easy-to-dissolve substances.

As an ion-exchange membrane suitable for the manufacture of the MEA according to the present invention, a perfluorinated sulfonic acid proton-exchange membrane is most preferably used.

The pretreatment step, a first step, is conducted in the following manner.

First, the surface of the ion-exchange membrane is roughed by sandblasting or sandpaper to enlarge the reaction surface area. After making the surface of the ion-exchange membrane rough in this manner, processes of cleaning and washing the ion-exchange membrane are repeatedly performed to remove impurities from the ion-exchange membrane. The cleaning process is conducted either by heating the ion-exchange membrane in pure water or using auxiliary equipment such as an ultrasonic cleaner, and the washing process comprises a procedure of heating the ion-exchange membrane in a solution of acid, such as hydrochloric acid, sulfuric acid, or the like, in order to remove impurities from the surface of the ion-exchange membrane. In this respect, the most preferred acid is hydrochloric acid. The pretreatment step comprises the sub-steps of roughing the surface of the ion-exchange membrane, washing the ion-exchange membrane with pure water, and heating the ion-exchange membrane in acidic solution, these sub-steps preferably being repeated at least one time.

The adsorption step, which is the second step, is performed in the following manner.

In the step of adsorbing catalyst ions, the ion-exchange membrane is immersed for a given time or longer in a solution having dissolved therein a metal compound functioning as an electrochemical catalyst and in a solution containing metal compounds dissoluble by post-treatment, so as to cause the metal ions and the dissoluble metal ions to penetrate into the ion-exchange membrane. In this step, the main operating variables are temperature, immersion time, stirring or the like.

The electrochemical catalyst which can be applied in this step is any one or a mixture of two or more selected from among ruthenium, iridium, manganese, cobalt, nickel, palladium, chromium and platinum. In order to cause this metal catalyst to penetrate into the ion-exchange membrane, it is preferable that a compound having chloride or nitrate, such as RuCl₃, IrCl₃, Mn(NO₃)₂, Co(NO₃)₂, Ni(NO₃)₂, SnCl₃, PdCl₂ or CrCl₃ be used as a precursor. As a catalyst for anodic oxidation, it is preferable to use any one or a mixture of two or more selected from among platinum, iridium and ruthenium having low oxygen generation overvoltage, and tin (Sn) having stability in a wide pH range, and as a catalyst for cathodic hydrogen ion oxidation, it is preferable to use platinum or the like, having low hydrogen overvoltage.

Also, the concentration of the anode catalyst in the anode is preferably 0.01-5 mmole, and the concentration of the cathode catalyst in the cathode is preferably 0.01-5 mmole. If the concentration of the anode or cathode catalyst is less than 0.01 mmole, it will be difficult to cause the catalyst ion component to penetrate into the ion-exchange membrane, and if it is more than 5 mmole, unreacted catalyst will be present, wasting the expensive precious catalyst.

The temperature suitable for the step of adsorbing the metal ions is in a range of 10-80° C. If the temperature is 10° C. or lower, it will be difficult to cause the catalyst ions to penetrate into the ion-exchange membrane, and if it is 80° C. or higher, the deformation of the ion-exchange membrane will be severe, making operation difficult. The temperature in the adsorption step is more preferably in the range of 40-60° C.

As the metal ion for forming the porous structure, it is preferable to use any one or a mixture of two or more selected from among aluminum, magnesium and zinc, in view of a property of easy dissolution in a reducing agent solution to be described below. The metal ion is preferably used in the form of chloride, nitrate or the like. The metal to be dissolved preferably has a molar concentration ratio of 10-90% relative to the anode catalyst. If the molar concentration ratio of the metal is less than 10%, the penetration of the porous structure-forming ions into the ion-exchange membrane will be difficult to conduct due to the interference of platinum ions, and on the other hand, if it is more than 90%, the porous structure-forming ions will not be sufficiently removed in the dissolution process, deteriorating the performance of the resulting MEA. In this step, the concentration of the metal to be dissolved is more preferably 30-70%, and the size of the pores is preferably in the range of 0.01-0.1 μm.

The reduction and dissolution step, a third step, is performed in the following manner.

The reduction and dissolution step is a process of reducing the metal catalyst ions penetrated and fixed to the ion-exchange membrane into a metal catalyst using a reducing agent (e.g., NaBH₄) and a reduction promoter (e.g., NH₄OH or NaOH) and, at the same time, dissolving the dissolution ions. In this step, the reducing agent having reduction and dissolution functions and the reduction promoter (alkaline component) serving to promote dissolution and reduction are introduced into a constant-temperature bath, and the solution is stirred at low speed. A preferred temperature in the reduction reaction is 20-80° C. If the temperature is less than 20° C., the reaction rate of the alkaline component serving to promote the dissolution function of the reducing agent and the reduction reaction will be low, leading to a decrease in reduction efficiency, and if it is more than 80° C., the deformation of the ion-exchange membrane will be severe, as in the adsorption step, making operation difficult. The reduction temperature is more preferably in the range of 40-70° C. After completion of this reduction and dissolution step, the post-treatment step of washing the ion-exchange membrane with water or hydrochloric acid and storing the membrane is performed.

In forming the electro-catalytic layers on both surfaces of the ion-exchange membrane as described above, if the catalyst materials of the anode and the cathode are the same, the porous electro-catalytic layers can be formed in a one-step process, but if the anode catalyst and the cathode catalyst are different from each other, the porous electro-catalytic layers will be formed through two different processes. Moreover, in the present invention, the above-described adsorption, reduction and dissolution, and post-treatment steps may also be repeated following the post-treatment step in order to increase the amount of impregnation of the catalysts.

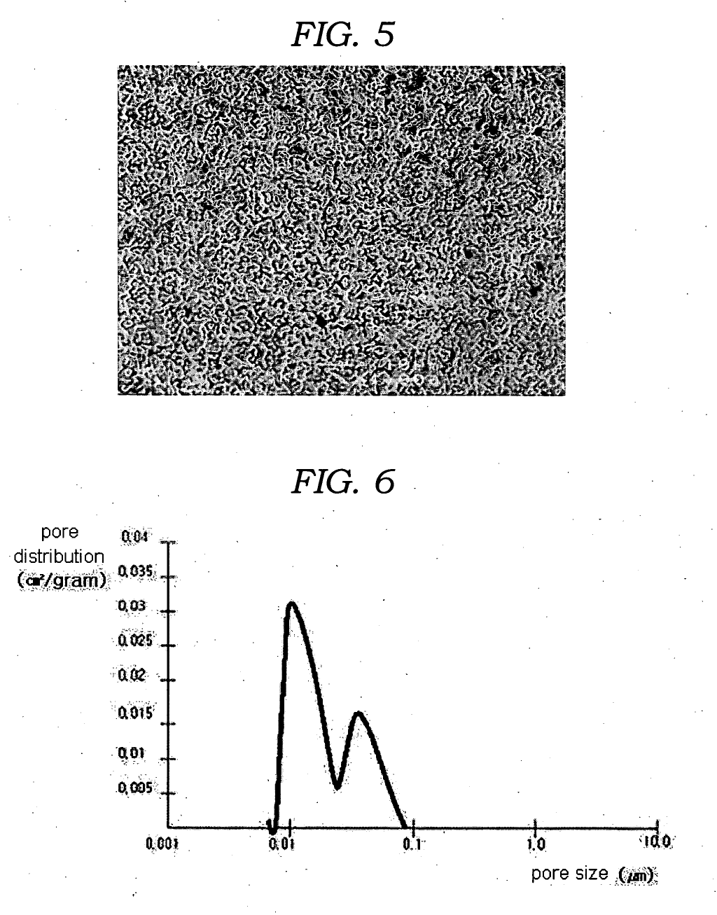

When the manufacture of the MEA is performed through the above-described steps, the porous electro-catalytic layers will be formed on both surfaces of the ion-exchange membrane as shown in FIG. 5. In this regard, the distribution of pores in the porous electro-catalytic layers is shown in FIG. 6. FIG. 5 is a photograph taken for the electro-catalytic layer of the membrane electrode assembly manufactured according to the present invention, and FIG. 6 is a graphic diagram showing the pore distribution of the electro-catalytic layer shown in FIG. 5. As can be seen in FIG. 6, pores having a size of 0.01-0.1 μm are evenly distributed in the electro-catalytic layer.

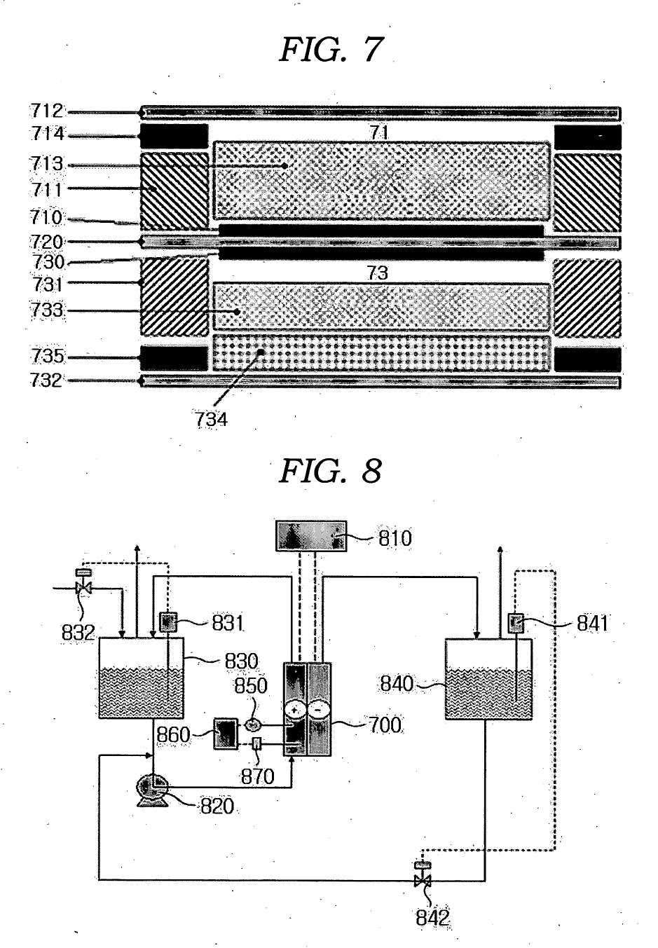

FIG. 7 is a diagram showing the structure of a unit electrochemical cell having a membrane electrode assembly manufactured according to the present invention. As shown in FIG. 7, the unit electrochemical cell according to the present invention comprises the MEA constructed to have the porous electro-catalytic layers on both surfaces of the ion-exchange membrane as described above. In this respect, the MEA consists of an ion-exchange membrane 720, and an anode 710 and a cathode 730, each of which is made of a porous electro-catalytic layer formed on each of both surfaces of the ion-exchange membrane 720. Herein, an anode chamber 71 and a cathode chamber 73, which are formed by the anode 710 and the cathode 730, respectively, contain a product and a reactant and are configured to face each other.

The anode chamber 71 is formed so as to be isolated from the external environment by a frame 711 and a separator 712, and has the anode 710 and an anode chamber MEA support 713. Between the frame 711 and the separator 712, a gasket (packing) 714 is disposed for preventing the reactant and product in the anode chamber 71 from leaking to the outside.

The cathode chamber 73 is formed so as to be isolated from the external environment by a frame 731 and a separator 732 and has the cathode 730, a cathode chamber MEA support 733, and a metal foam 734 located between the cathode chamber MEA support 733 and the separator 732. Herein, the metal foam 734 is made of a material suitable for the environment of the electrochemical cell, functions to control the pressure within the unit electrochemical cell at a uniform level, and is not an essential element at all times. Between the frame 731 and the separator 732, a gasket 735 is disposed for preventing a reactant and product in the cathode chamber 73 from leaking to the outside.

Among the elements of the unit electrochemical cell, the frames 711 and 731, the separators 712 and 732 and the gaskets 714 and 735 have suitable holes such that the reactant or product can easily flow in and out through the unit electrochemical cell.

Hereinafter, an example for comparatively measuring the performance of an MEA manufactured through a method according to the prior art and the performance of an MEA manufactured through a method according to one embodiment of the present invention will be described. It is to be understood, however, that the present invention is not limited to this example.

### INVENTIVE EXAMPLE 1

### Porous Anode Catalytic Layer (Pt)/Porous Cathode Catalytic Layer (Pt)

As an ion-exchange membrane, the perfluorosulfonic cation-exchange membrane Nafion commercially available from DuPont was used. Both surfaces of the membrane were roughed with sandpaper (Norton 600A), and then the membrane was immersed in ultrapure water for about 1 hour, taken out of the water and cut to a given size.

A. Formation of Cathode Catalytic Layer

(1) Pretreatment Step

In order to remove organic substances present in the ion-exchange membrane cut to a given size, the ion-exchange membrane was heated in 3% H₂O₂ aqueous solution for about 40 minutes and then washed with pure water. Also, the ion-exchange membrane was heated in a 1M H₂SO₄ solution for about 30 minutes, washed with pure water and then heated in ultrapure water for about 1 hour.

(2) Adsorption Step

Methanol containing 0.3 mM AlCl₃(aluminum chloride) and 0.3 mM pt(NH₃)₄Cl₂(tetra-amine platinum chloride hydrate, 98%), and water, were mixed with each other at a volume ratio of 1:3 to make a mixed solution. Then, the ion-exchange membrane washed in the pretreatment step was immersed in the mixed solution for about 40 minutes so as to cause the platinum ions and aluminum ions diffuse and adsorb onto the inside of the ion-exchange membrane.

(3) Reduction Step

A solution of pH 13, preheated to 50° C., was mixed with NaBH₄to make a 1 mM reducing solution. In the reducing solution, the ion-exchange membrane was immersed to remove the platinum solution adsorbed in the adsorption step, and then 60 ml of the reduction solution was also added thereto. Thereafter, the ion-exchange membrane in the reducing solution was subjected to a reduction process for about 2 hours with stirring, and then the ion-exchange membrane was immersed in 0.5M H₂SO₄ for about 2 hours and in ultrapure water for about 1 hour, followed by storage.

B. Formation of Anode Catalytic Layer

(1) Pretreatment Step

The ion-exchange membrane was washed with pure water and then heated in ultrapure water for about 1 hour.

(2) Adsorption Step

This step was conducted in the same manner as in the adsorption step described in the process of forming the cathode catalytic layer.

(3) Reduction Step

This step was conducted in the same manner as in the reduction step described in the process of forming the cathode catalytic layer.

C. Evaluation of Unit Electrochemical Cell

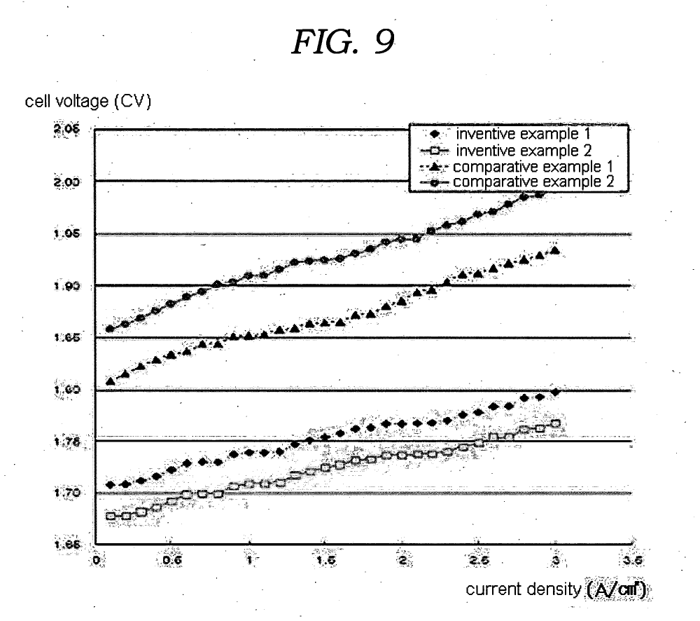

The performance of a unit electrochemical cell comprising the MEA manufactured through the above-described steps was evaluated using a test system as shown in FIG. 8. The unit electrochemical cell used in the test of the present invention was constructed as shown in FIG. 8. FIG. 8 is a process diagram used to evaluate an electrochemical cell comprising the membrane electrode assembly manufactured according to each of the prior art and the present invention.

As shown in FIG. 8, direct current was supplied to an electrochemical cell 700 using a direct current power supply 810, and distilled water having a resistivity of 1 Mega-ohm/cm or higher was used as raw material water. Herein, the water was fed into the anode chamber through a pump 820, and oxygen generated in the anode chamber and unreacted water were separated from each other in a water storage cell 830, in which the water level of the water storage cell 830 was sensed by a level sensor 831, and the introduction of water into the water storage cell was controlled by an on-off valve 832. Also, hydrogen generated in the cathode chamber was separated in a gas-liquid separator 840 for separating hydrogen from water and discharged. Herein, the level of the gas-liquid separator 840 was sensed by a level sensor and controlled by an on-off valve 842. Also, the temperature of an electrolyte solution was set to 80° C. by measuring the temperature of the electrochemical cell 700 with a sensor 850 and controlling the temperature using an electrical heater 870 and a controller 860, and generated cell voltage (CV) was measured.

D. Results

The test results for inventive example 1 were shown in FIG. 9.

FIG. 9 is a graphic diagram showing the comparison of performance test results between Comparative Examples and Inventive Examples, obtained using the test system of FIG. 8.

### INVENTIVE EXAMPLE 2

### Porous Anode Catalytic Layer (Pt—Sn—Ir)/Porous Cathode Catalytic Layer (Pt)

An ion exchange membrane used in this Example was the same as used in Inventive Example 1.

A. Formation of Cathode Catalytic Layer

(1) Pretreatment Step

This step was conducted in the same manner as the pretreatment step of the process for forming the cathode catalytic layer in Inventive Example 1.

(2) Adsorption Step

This step was conducted in the same manner as the adsorption step of the cathode catalytic layer-forming process of Inventive Example 1.

(3) Reduction Step

This step was conducted in the same manner as the reduction step of the cathode catalytic layer-forming process of Inventive Example 1.

B. Formation of Anode Catalytic Layer

(1) Pretreatment Step

The ion-exchange membrane was washed with pure water and heated in ultrapure water for about 1 hour.

(2) Adsorption Step

Methanol containing 0.3 mM AlCl₃(aluminum chloride), 0.1 mM pt(NH₃)₄Cl₂(tetra-amine platinum chloride hydrate, 98%), 0.25 mM SnCl₃(Tin Chloride) and 0.1 mM iridium chloride (iridium chloride hydrate, 98%), and water, were mixed with each other at a volume ratio of 1:3 to make a mixed solution. The ion-exchange membrane washed in the pretreatment step was immersed in the mixed solution for about 40 minutes so as to allow the ions to diffuse and adsorb on the inside of the ion-exchange membrane.

(3) Reduction Step

This step was performed in the same manner as the reduction step of the cathode catalytic layer-forming process of Inventive Example 1.

C. Evaluation of Unit Electrochemical Cell

The evaluation of the electrochemical cell was performed in the same manner as in Inventive Example 1.

D. Results

The test results for Inventive Example 2 are shown in FIG. 9.

### COMPARATIVE EXAMPLE 1

Cathode and anode catalytic layers were formed according to a method mentioned in the prior art, and an electrochemical cell having these electrode layers was evaluated in the same manner as in Inventive Example 1. The test results for Comparative Example 1 are shown in FIG. 9.

### COMPARATIVE EXAMPLE 2

### Electro-Catalytic Layers Fabricated by Hot Pressing

The performance of an electrochemical cell purchased from Ionic Power, USA, which had electrodes fabricated according to the hot pressing method, was evaluated according to the evaluation method described in Inventive Example 1. The test results for Comparative Example 2 are shown in FIG. 9.

As can be seen in FIG. 9 showing the test results for Inventive Examples 1 and 2 and Comparative Examples 1 and 2, Inventive Examples 1 and 2 corresponding to the present invention have low cell voltage at the same current density, compared to Comparative Example 1 and 2. This suggests that the present invention has improved performance compared to the prior art while using a reduced amount of precious metals (including platinum) for forming electro-catalytic layers.

As described above in detail, according to the present invention, the electro-catalytic layers are made porous, and thus the amount of precious metal used can be reduced so that the manufacturing cost of the electro-catalytic layers can be greatly reduced (by about ½ compared to the prior art). In addition, the reaction efficiency of the catalytic layers can be stabilized to improve the efficiency thereof.

Although the technical details of the membrane electrode assembly having the porous electro-catalytic layers, the manufacturing method thereof and the electrochemical cell have been described with reference to the accompanying drawings, these details are given to illustrate the most preferred embodiment of the present invention and are not intended to limit the scope of the present invention.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A membrane electrode assembly for electrochemical cells, which has electro-catalytic layers forming electrodes on both surfaces of an electrolyte membrane, wherein the electro-catalytic layers are porous electro-catalytic layers having a plurality of pores evenly distributed therein.

2. The membrane electrode assembly of claim 1, wherein the pores are distributed in a size of 0.01-0.1 μm so as to allow a reactant and a product to easily flow in and out from the electrolyte membrane.

3. A method for manufacturing a membrane electrode assembly for electrochemical cells, which has electro-catalytic layers forming electrodes on both surfaces of an electrolyte membrane, the method comprising:
a pretreatment step of washing the electrolyte membrane;
an adsorption step of immersing the pretreated electrolyte membrane in a solution containing electrode catalyst ions and easy-to-dissolve metal ions, so as to cause the ions to penetrate into a surface and inside of the electrolyte membrane and fix them thereto;
a reduction and dissolution step of reducing the electro-catalytic ions fixed to the electrolyte membrane using a reducing agent to form a catalyst while dissolving the easy-to-dissolve metal ions, thus forming porous electro-catalytic layers; and
a post-treatment step of washing the electrolyte membrane having the porous electro-catalytic layers coated on both surfaces thereof.

4. The method of claim 3, wherein the electrode catalyst used in the adsorption step is any one or a mixture of two or more selected from the group consisting of ruthenium, iridium, manganese, cobalt, nickel, palladium, chromium and platinum.

5. The method of claim 3, wherein the easy-to-dissolve metal used in the adsorption step is any one or a mixture of two or more selected from the group consisting of aluminum, magnesium and zinc.

6. The method of claim 4, wherein the easy-to-dissolve metal used in the adsorption step is any one or a mixture of two or more selected from the group consisting of aluminum, magnesium and zinc.

7. An electrochemical cell comprising:
a membrane electrode assembly having electrode catalyst layers forming electrodes on both surfaces of an electrolyte membrane;
and a packing, a separator and a frame, which are configured with respect to the membrane electrode assembly so as to make supply and discharge of a reactant and a product possible,
wherein the electro-catalytic layers are porous electro-catalytic layers having a plurality of pores evenly distributed therein.
